(19) United States
(12) Patent Application Publication
(10) Pub. No.: US 2024/0253369 A1
(43) Pub. Date: Aug. 1, 2024

(54) AUTOMATED GARMENT LOADING

(71) Applicant: Kornit Digital Ltd., Rosh HaAyin (IL)

(72) Inventors: Yogev ALONI, Rosh HaAyin (IL); Boris IDELCHIK, Petah Tikva (IL); Pavel KOROLIK, Petah Tikva (IL); Harel YIZHAK, Rehovot (IL); Idan PERETZ, Shoham (IL); Meir WARULKER, Rosh HaAyin (IL); Nadav MORDECHAI, Tel Aviv (IL)

(73) Assignee: Kornit Digital Ltd., Rosh HaAyin (IL)

(21) Appl. No.: 18/561,316

(22) PCT Filed: May 16, 2022
(86) PCT No.: PCT/IL2022/050508

§ 371 Date: Nov. 16, 2023

Related U.S. Application Data
(60) Provisional application No. 63/189,177, filed on May 16, 2021.

(51) Int. Cl. B41J 11/06; B08B 7/00; B41F 15/26; B41J 3/407; B41J 11/00

(52) U.S. Cl. CPC B41J 11/06; B08B 7/0028; B41F 15/26; B41J 3/4078; B41J 11/0015

(57) ABSTRACT

A reconfigurable form pallet provides a manual or automated feeder to a garment processor, such as a printer or the like, and is adapted for a garment having appendages such as sleeves. The pallet comprises an interchangeable flat pallet surface; a appendages and sleeves handling mechanism configured to take hold of said appendages as the garment slides onto the pallet; a moving roller with adhesive or shaver to collect dust, fibers, and such from the garment; rounded surfaces for smooth movement of the garment; flaps on both sides for attaching the garment to the pallet without wrinkles or deviations from the center;

### RELATED APPLICATION

This application claims the benefit of priority of U.S. Provisional Application No. 63/189,177 filed 16 May 2021, the contents of which are incorporated herein by reference in their entirety.

### FIELD AND BACKGROUND OF THE INVENTION

The present invention, in some embodiments thereof, relates to automated garment loading and, more particularly, but not exclusively, to modifications to a pallet to allow automated mounting of the garment on the pallet for printing or other purposes.

Loading paper for printing is well understood and technologies such as vacuum or rollers are able to grab and load sheets of paper onto high speed printers and other devices that use paper. However textiles and clothing are more difficult.

Textiles for printing often come in the form of ready-formed garments. In such a case the garment is to be fitted around a form-pallet, so that the upper side of the garment is over the pallet and the lower part of the garment is below the pallet. Fitting of the garment onto the form pallet may be manual, or mechanical grippers may be used to assist. For example, the operator may feed the ends of a garment onto mechanical grippers associated with the form pallet. However, garments are not uniform shapes. They include parts such as sleeves, pockets, buttons, trouser legs and collars, so that getting the garment correctly fitted above and below the form pallet is only part of the story.

In addition, dust and lint on the garment may spoil the print quality. The operator is often required to brush the garment prior to placing on the pallet.

Applicant's patent application IL2018/051408 deals with issues of gripping the garment so that the garment may be picked from a pile and pulled over the form pallet automatically. However, the issues of sleeves etc. are not addressed, and the upper and lower parts of the garment may still be caught on edges of the form pallet or other parts of the printing apparatus.

### SUMMARY OF THE INVENTION

The present embodiments relate to mechanical modifications for the smooth loading of a garment onto a pallet, so that loading may be carried out with ease by an operator or using mechanical grippers as preferred, and to ensure that printing may take place without interference by irregular parts of the garment such as the sleeves, or by dust or lint on the garment. Thus a roller coated with adhesive or a shaver may flatten the upper surface of the garment over the platen surface. Slides may smooth the passage of the upper and lower surfaces of the garment to slide above and below the platen respectively and a sleeve handling mechanism may handle the sleeves to ensure that the sleeves are kept away from the surface being printed.

According to an aspect of some embodiments of the present invention there is provided textile processing apparatus having a self-reconfigurable form pallet for a garment, the pallet having an approach direction from which a garment to be placed on the pallet approaches the pallet, and a travel direction in which the pallet approaches a processing machine for printing or wherein the processing machine approaches the pallet, the garment having an upper surface and a lower surface, the pallet comprising:
a plane or reconfigurable flat pallet surface; and
a roller coated with adhesive and/or having a shaver attached thereto, the roller being aligned with the flat pallet surface and located in the travel direction, the roller configured to pass over at least a printing area of the upper garment surface to adhesively remove dust, lint and other impurities from the upper garment printing area prior to printing.

In embodiments, the roller coated with adhesive and/or a shaver is retrievably mounted to advance towards and retreat from a plane of the upper garment surface.

In embodiments, the roller coated with adhesive and/or a shaver is flexibly mounted, thereby to accommodate local changes in thickness of the garment upper surface.

In embodiments, the roller coated with adhesive has first and second ends and a central axis between the first and second ends, the roller rotating around the central axis while held at the central axis by resilient mountings at the first and second ends.

According to a second aspect of the present invention there is provided a form pallet for a garment having appendages, the pallet having an approach direction from which a garment to be placed on the pallet approaches the pallet, and a travel direction in which the pallet approaches a machine for processing of the garment, the garment having an upper surface and a lower surface, the pallet comprising:
a rounded plane or configurable flat pallet surface; and
a sleeve handling mechanism configured to take hold of the appendages as the garment slides onto the pallet, and hold the appendages away from the flat pallet surface as the garment upper surface settles on the flat pallet surface, thereby to keep the appendages away from the processing of the garment.

In embodiments, the sleeve handling mechanism comprises arms outwardly located from respective sides of the form pallet, the arms being positioned for the appendages to slide within the arms as the garment slides onto the form pallet.

In embodiments, the sleeve handling mechanism comprises rounded front contours on respective arms facing the approach direction.

In embodiments, the arms are configured to rotate inwardly towards the pallet, thereby to fold the appendages into respective sides of the pallet.

In embodiments, the arms respectively comprise a bar extending outwardly from the arm in a direction away from the pallet, the arms being configured to rotate so that the respective bars fold the appendages towards the pallet.

In embodiments, the form pallet comprises flaps at respective sides, the flaps being rotatable over a rotating path to close over sides of the garment to pull the upper garment surface taut, and wherein the appendages are placed by the sleeve-handling mechanism into the rotating path, thereby to enable the flaps to close over the appendages.

In embodiments, the flaps comprise rounded front contours facing the approach direction.

In embodiments, the sleeve-handling mechanism comprises a mechanical gripper configured to receive each appendage and pull the appendage lengthwise along a side of the pallet.

In embodiments, the form pallet comprises at least one rounded front contour facing the approach direction.

In embodiments, the form pallet comprises at least a second rounded front contour facing the approach direction, such that the first of the rounded contours is positioned to guide the garment upper surface to slide over the form pallet and the second of the rounded contours is positioned to guide the garment lower surface to slide under the form pallet.

According to a third aspect of the present invention there is provided a method of palletizing a garment having appendages, comprising:
causing the garment having appendages to approach a form pallet from an approach direction, the garment having an upper surface and a lower surface;
sliding the garment onto the form pallet such that an upper surface of the garment slides above the form pallet and a lower surface of the garment slides below the form pallet,
holding the appendages as the garment slides onto the pallet aside from the upper surface of the garment.

In the method, the appendages, while being held alongside the pallet may be aligned along sides of the pallet.

In the method, the appendages may be held by sliding within arms alongside the pallet, the arms rotating inward towards the pallet to align the appendages along the sides.

In the method, the appendages may be grabbed by a rotating bar and rotated to align along sides of the pallet.

The method may comprise gripping the appendages and pulling the appendages along respective sides of the pallet.

The method may comprise closing flaps over respective sides of the pallet, the flaps thereby holding the sleeves.

The appendages may comprise sleeves.

The method may comprise applying an adhesive-coated surface to the upper side of the garment to clear the upper side of the garment of dust or lint, or a shaving blade to remove the same or air flow/vacuum.

According to a fourth aspect of the present invention there is provided a form pallet for a garment, the pallet having an approach direction from which a garment to be placed on the pallet approaches the pallet, and a travel direction in which the pallet approaches a machine for processing of the garment, the garment having an upper surface and a lower surface, the pallet comprising:
a flat pallet surface; and
at least a first rounded front contour facing the approach direction.

In embodiments, the form pallet comprises flaps at respective sides, the flaps being rotatable over a rotating path to close over sides of the garment to pull the upper garment surface taut.

In embodiments, the form pallet comprises at least a second rounded front contour facing the approach direction, such that the first of the rounded contours is positioned to guide the garment upper surface to slide over the form pallet and the second of the rounded contours is positioned to guide the garment lower surface to slide under the form pallet.

A fifth aspect of the present invention may entail a method for loading a garment onto the form pallet discussed herein, the method comprising sliding a garment via the at least a first rounded contour onto the form pallet.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic diagram showing a form pallet and loading mechanism with rounded or contoured edges according to embodiments of the present invention;

FIG. 2 is a simplified schematic diagram showing a form pallet and a roller according to embodiments of the present invention;

FIG. 3 is a simplified schematic diagram showing a sleeve handling mechanism according to embodiments of the present invention;

FIGS. 4, 5 and 6 are three diagrams showing successive positions of the sleeve handling mechanism of FIG. 3;

FIG. 7 is a simplified schematic diagrams showing a form pallet with contoured edges in the feed direction according to embodiments of the present invention;

FIG. 8 is a simplified schematic diagram showing a sleeve handling mechanism using sleeve grippers according to an embodiment of the present invention;

FIGS. 9A and 9B are images showing sides of a garment held together with sleeves in the flaps of a form pallet according to an embodiment of the present invention;

FIGS. 10 and 11 are images of a garment loaded onto a form pallet, with sleeves positioned to be held by the flaps, according to embodiments of the present invention;

FIGS. 12 and 13 are simplified flow charts of the process of loading garments onto a form pallet according to embodiments of the present invention, for the cases of a garment with sleeves and without sleeves respectively;

FIG. 14 illustrates lower pallet parts according to embodiments of the present invention; and

FIG. 15 illustrates parts that slide to reconfigure a pallet according to embodiments of the present invention.

### DESCRIPTION OF SPECIFIC EMBODIMENTS OF THE INVENTION

The present invention, in some embodiments thereof, relates to automated garment loading and, more particularly, but not exclusively, to modifications to a system to allow automated mounting of the garment on the pallet for printing or other purposes.

A form pallet provides a feeder to a garment processor, such as a printer or the like, and is adapted for a garment having appendages such as sleeves. The pallet comprises a flat pallet surface, and a sleeve handling mechanism configured to take hold of said appendages as the garment slides onto the pallet. The sleeve-handling mechanism holds the appendages away from the flat pallet surface as the garment upper surface settles on the flat pallet surface, thereby to keep the appendages away from the processing of said garment. Flaps, included with the pallet to hold the garment from the sides and tension the upper surface, close over the appendages which are held in the rotating path of the flaps so that the appendages are kept firmly in position during the processing.

In the present embodiments a sleeve handling mechanism grabs hold of and moves away the sleeves, trouser legs, frills or other garment extensions, herein appendages, from the printing area, and/or at the same time keeping the sleeves etc. from flapping or extending outwards so they do not get caught on parts of the printing apparatus. Rounded or sliding edges added to the pallet and surrounding parts ensure that the upper and lower parts of the garment fit smoothly around the form pallet without getting caught, so that garment placement is smooth and does not need to be corrected or repeated. Furthermore an adhesive covered cylinder rolls over the printing area of the garment as the pallet advances into the printing area, to remove dust, lint etc.

An embodiment may comprise a reconfigurable form pallet provides a manual or automated feeder to a garment processor, such as a printer or the like, and is adapted for a garment having appendages such as sleeves. The pallet comprises an interchangeable flat pallet surface; a appendages and sleeves handling mechanism configured to take hold of said appendages as the garment slides onto the pallet; a moving roller with adhesive or shaver to collect dust, fibers, and such from the garment; rounded surfaces for smooth movement of the garment; flaps on both sides for attaching the garment to the pallet without wrinkles or deviations from the center;

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

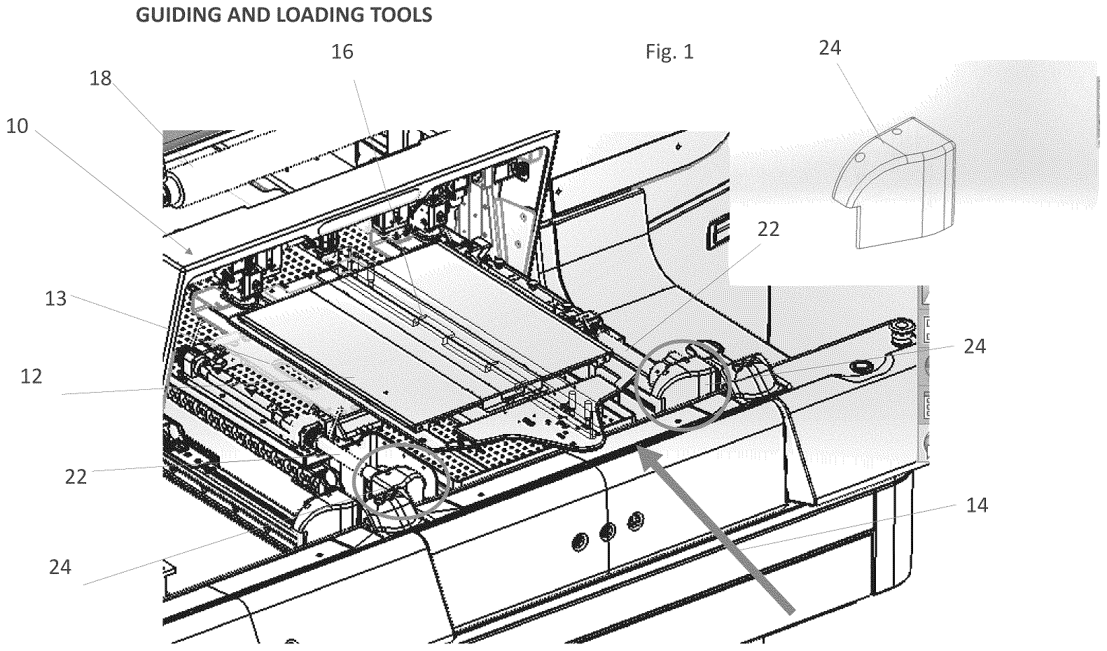

Referring now to the drawings, FIG. 1 illustrates the feed part 10 of a textile printing apparatus. The apparatus has a form pallet 12 for loading a garment and the form pallet has a flap 13 at either side which closes over the garment to hold the garment in position under tension on the pallet.

The pallet has an approach direction—arrow 14—from which a garment to be placed on the pallet 12 approaches the pallet. The pallet then travels in the same direction into the printing machine for printing. The garment has an upper surface that slides over the form pallet and a lower surface that slides under the pallet. The upper surface of the garment is thus located over flat pallet surface 16 and provides a flat surface of the garment for printing. As the pallet takes up position on the pallet, flaps 13 close to pull down on the sides of the garment and pull the upper surface of the garment into tension.

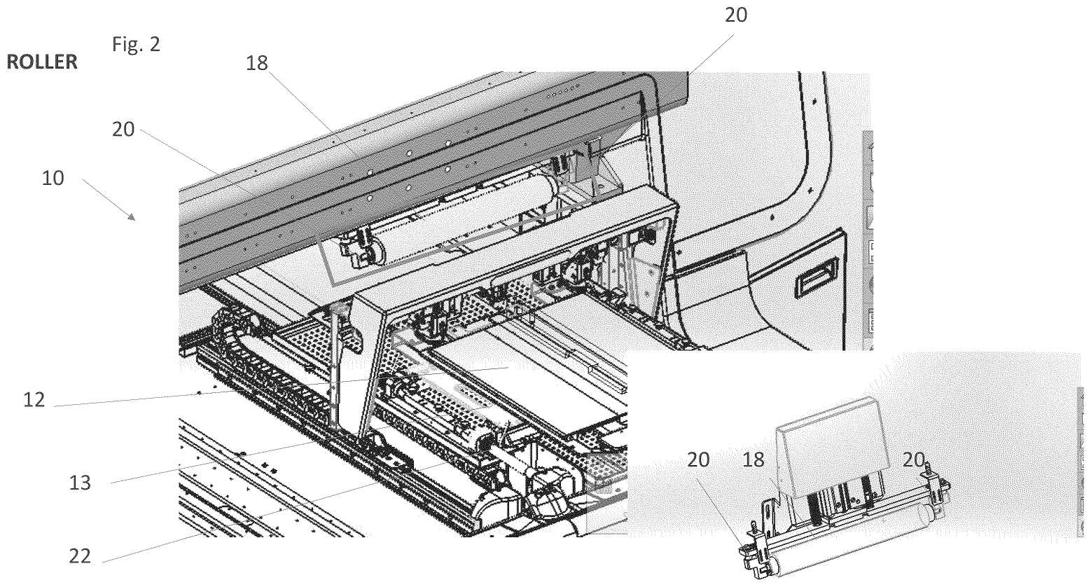

A roller coated with adhesive 18, shown more fully in FIG. 2, is aligned with the flat pallet surface and located in the travel path of the pallet into the printer. The roller rolls over the printing area of the upper garment surface to remove dust, lint and other impurities from the upper garment printing area to leave a clean surface for printing.

The roller coated with adhesive is mounted on mountings 20 which are retrievable so that the roller may be advanced towards and retrieved from the plane of the upper garment surface. The mountings 20 may be flexible, so as to accommodate local changes in thickness of the garment upper surface. Thus for example the garment may have pockets or buttons or other parts that increase or decrease the thickness, and the resilience of the mountings allows the roller to manage such changes in thickness.

Thus, the roller coated with adhesive may be axially mounted, to rotate around its central axis.

Returning now to FIG. 1, and the garment may have arms 22 on either side of the pallet 12 and flaps 13. The arms may be fronted by rounded elements 24, see insert, which guides the garment sides and appendages such as sleeves, trouser legs, frills and the like inwardly towards the pallet and prevents the garment or appendages getting caught on parts of the system and thus prevent it from being loaded on the pallet

It is noted that although FIG. 1 illustrates a pallet with flaps, the present embodiments relate to the loading of any kind of pallet, and in particular for any kind of automatic loading of form pallets with garments for any kind of garment processing, including ironing or pressing, printing, to include digital printing and screen printing, scanning and any other process that may be carried out on a garment. Using the present embodiments, the appendages slide with the garment and are retained alongside the pallet, and in the illustrated case of the use of flaps the appendages may be held in the rotation path of the flaps 13. The flaps 13 then close over the sides of the pallet to perform their primary function of holding the sides of the garment so as to tension the upper surface of the garment to form a good printing surface. Additionally the flaps close over the appendages and accordingly hold the appendages at the side of the pallet. Thus, the appendages are at the same time kept away from the top of the garment and are kept away from riding loosely inside the printing apparatus.

The garment may be slid over the pallet by an operator, or the base of the garment may be fixed into mechanical grippers which then retract across the pallet to pull the garment over the pallet. The grippers may pull the upper side of the garment clear of the top of the pallet. The arms 22 form a sleeve handling mechanism and guide the appendages inwardly as the garment slides onto the pallet. Accordingly the appendages are guided to the sides of the pallet, away from the flat upper pallet surface 16 as the garment upper surface settles on the flat pallet surface where they can be securely held by the flaps as discussed above.

It is to be noted that many garments do not have appendages, but may still need to be loaded smoothly onto a form pallet.

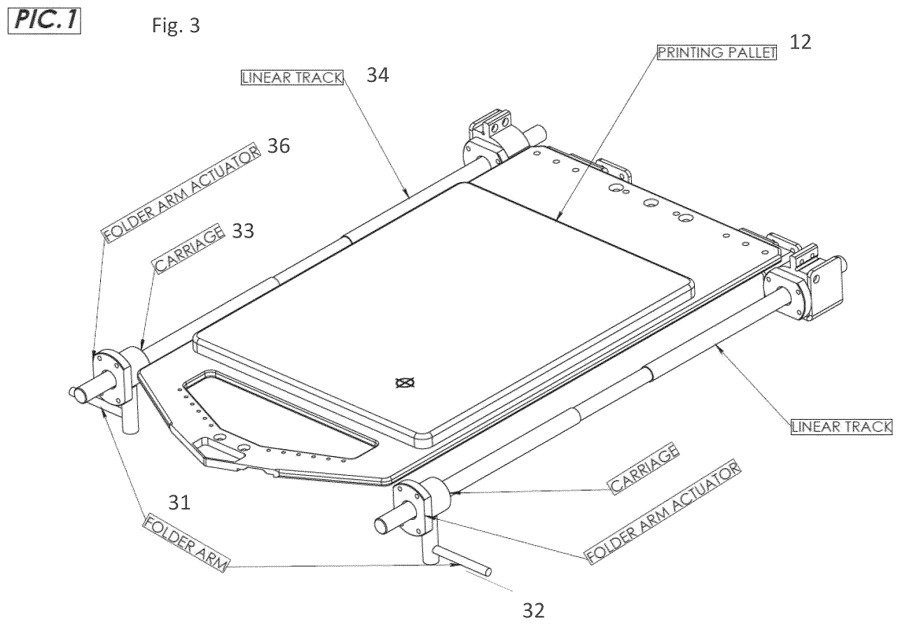

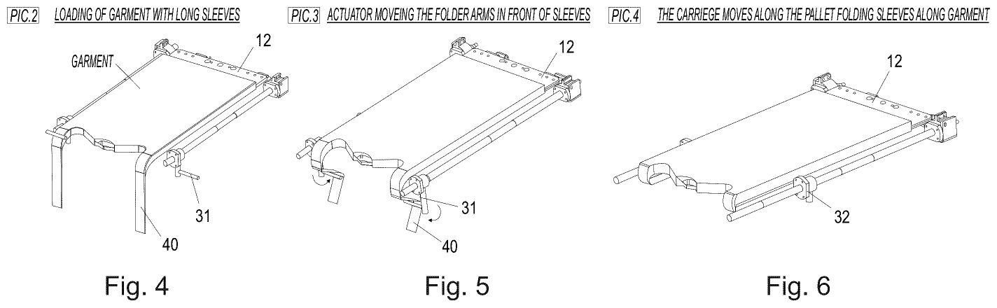

An alternative embodiment of the arm is shown in FIG. 3. In FIG. 3, form pallet 12 is as before. Flaps 13 are omitted for simplicity. The arm 30 comprises a bar 31 which is part of a folder arm 32, in turn mounted on a carriage 33 which slides on a linear track 34 powered by an actuator 36. Instead of a linear track and an actuator, a telescopic arm may be used, with the folder mounted on the end and moving inward as the arm telescopes. In use the bar 31 starts in an initial position as shown in FIG. 4, with garment appendage 40 hanging down from the approach end of the pallet 12, then rotates inwardly down and under towards the pallet, FIG. 5, to capture the front of the appendage 40 and then moves back towards the back of the pallet (the printing apparatus end) FIG. 6, to fold the length of the appendage along the lower side of the pallet 12. That is to say the arms comprise bar 31 extending outwardly from the arm away from pallet 12. Rotation is provided so that the bars fold the appendages towards the pallet and as shown, may leave the arms aligned along the sides of the pallet, again so that the appendages may be held under the flaps as the flaps close.

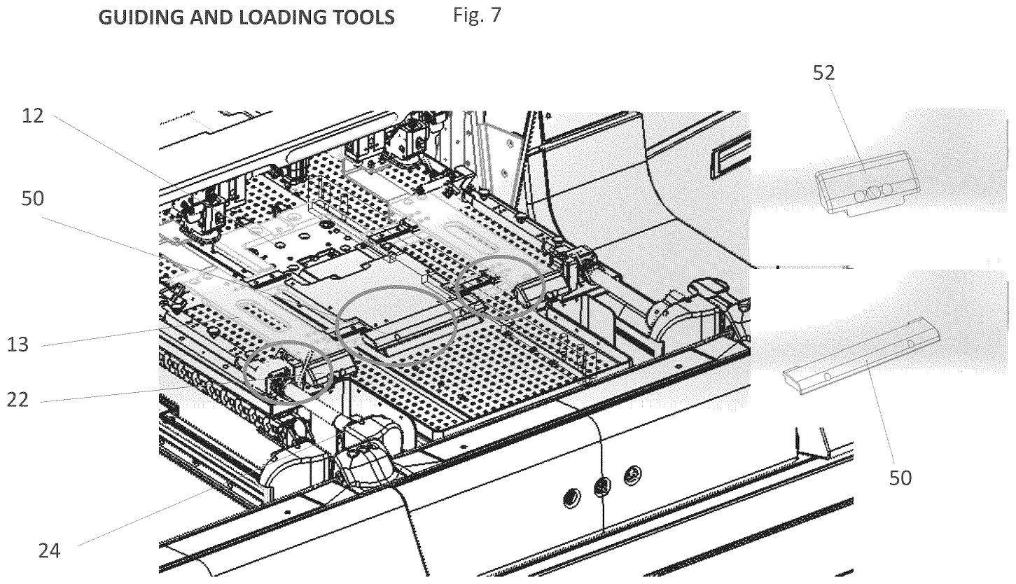

Reference is now made to FIG. 7, which shows form pallet 12 having a rounded front contour 50 facing the approach direction, to facilitate easy sliding of the garment onto the pallet. Side arms 22 also have rounded front contours 24 as before that encourage the garment's sides, sleeve or other appendage to move inwardly. The side arms 22 may facilitate the sliding of appendages such as sleeves and then the arms may fold inwards to fold the sleeves onto the side of the pallet. In an embodiment, the form pallet 12 may have separate rounded front contours 50 for both the top and the bottom, so that the top of the garment is guided over the top of the pallet and the bottom of the garment is guided under the bottom of the pallet. Flaps 13 also have rounded contours 54 at the front to ensure that neither the garment nor any appendage catches on the flap. The rounded front contours thus serve two purposes, firstly to ensure that no part of the garment gets caught and secondly to ensure smooth loading of the garment onto the pallet. That is to say, the loading involves straightforward sliding of the garment into the printing position, so that no further intervention of the operator is needed, and it should particularly reduce the necessity for unloading and reloading the garment. It is to be noted that rounded contours for smooth loading may be used irrespective of whether the garment has sleeves or other appendages, and for situations dedicated to garments without appendages, the system of the present embodiments may dispense with the sleeve-handling mechanism altogether.

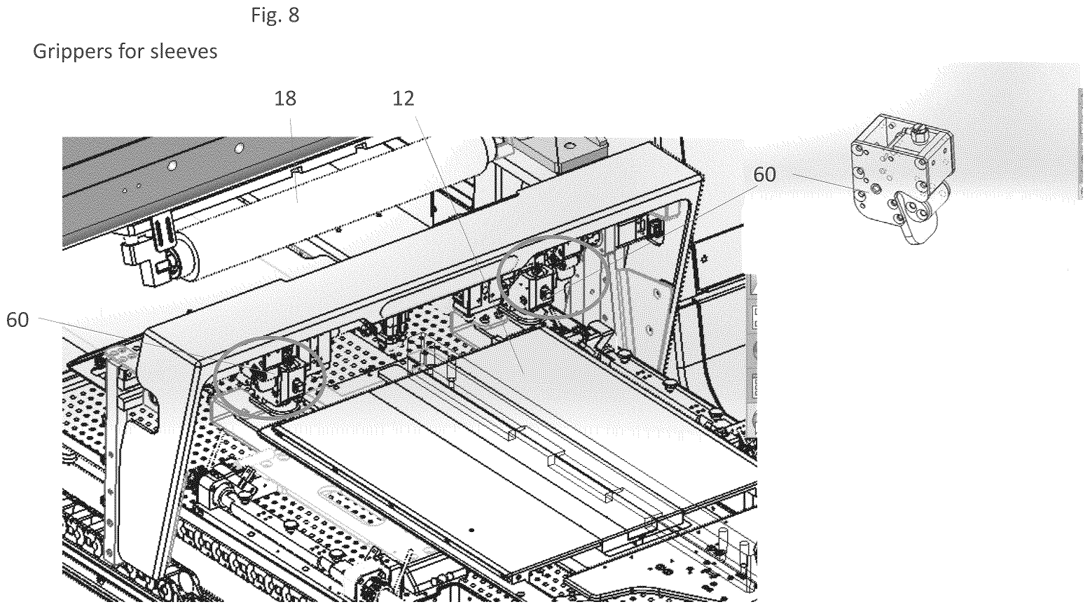

Reference is now made to FIG. 8, which shows pallet 12 as before with roller coated with adhesive 18 and mechanical grippers 60. In a further embodiment of the sleeve handling mechanism, an extra pair of mechanical grippers 60, also shown in insert, take hold of the base of the sleeves or other appendages and pull the appendages along the sides of the pallet to align the appendages along the rotation path of the flaps 13. The appendages are released and flaps 13 then close over the appendages. The flaps then hold the appendages firmly as the pallet passes through the apparatus.

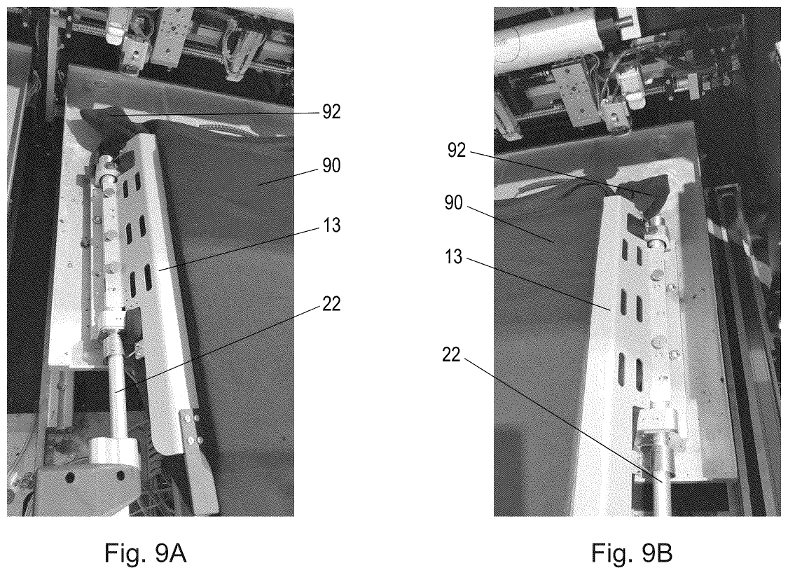

FIGS. 9A and 9B show a garment 90 on the pallet, with flaps 13 closed over the sides of the garment to hold the upper surface firmly in position from either side. Arms 22 have folded the sleeves 92 under the flaps so that they are firmly held in the pallet but are out of the way of the printing area.

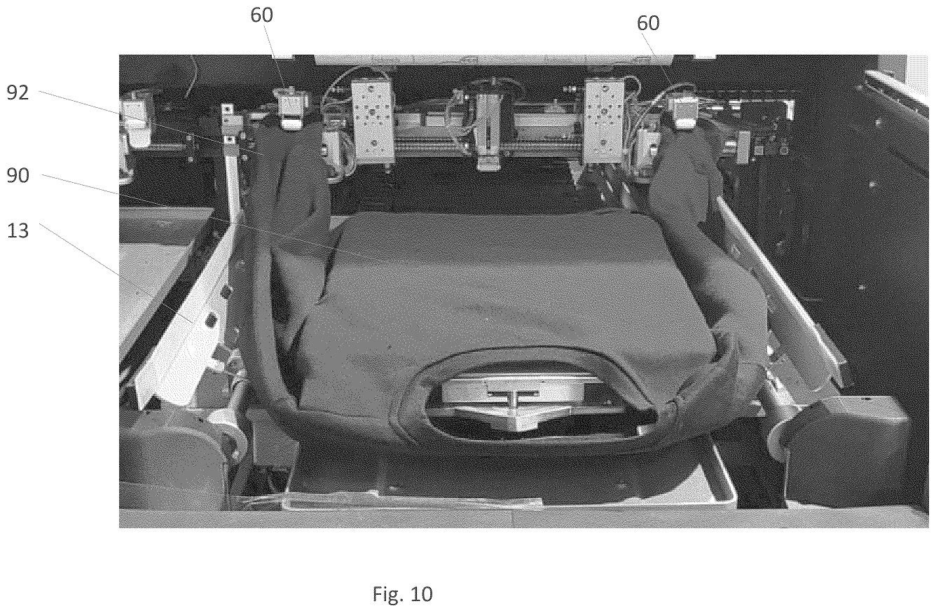

FIG. 10 shows garment 90 on a pallet. Flaps 13 are still open, and the sleeves 92 are held by sleeve grippers 60 in position so that the flaps 13 may close over them.

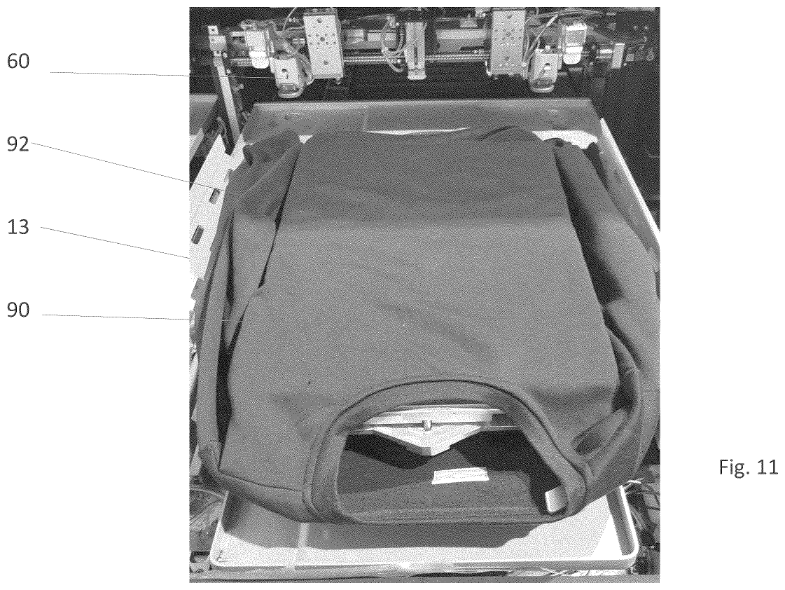

FIG. 11 shows garment 90 in position on the pallet. The grippers 90 have released the sleeves 92 and flaps 13 are still open.

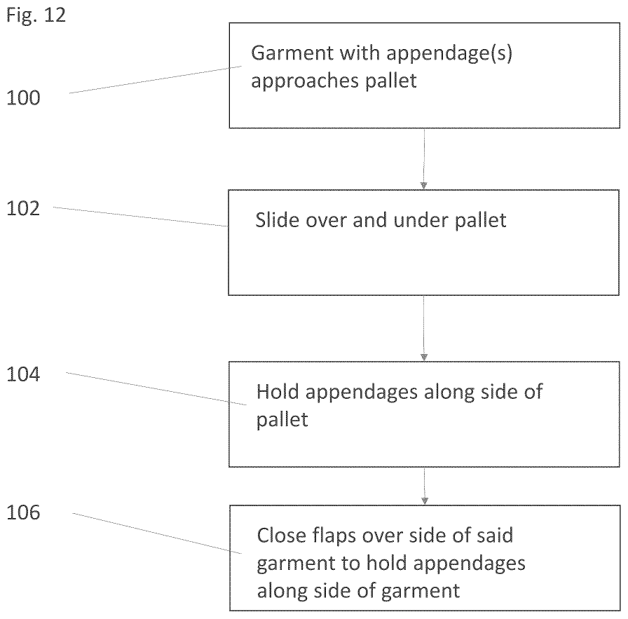

Reference is now made to FIG. 12, which is a simplified flow chart showing a method of palletizing a garment having appendages. The garment having appendages, sleeves, trouser legs, frills etc. is made to approach the pallet and is then made to slide 102 over the pallet, typically by having the base edge of the garment fixed in grippers which pull the garment over the pallet. In box 104, the appendages are held to the side, as the garment slides onto the pallet, so that the appendages do not interfere with the upper surface of the garment or fall away to the side waiting to be caught in moving parts of the printing apparatus. In box 106, the appendages, while being held alongside said pallet are folded under side flaps of the pallet as the flaps close over the sides of the garment.

The appendages may be held by sliding within arms alongside the pallet, the arms rotating inward towards the pallet to fold the appendages into the path of the flaps. Alternatively, the appendages may be gripped and pulled alongside the garment by mechanical grippers, and in a further alternative, the appendages may be caught on a rotating bar and rotated to fold onto a side of the pallet.

An adhesive-carrying surface or a shaver may be applied to the upper side of the garment to clear the upper side of said garment of dust or lint, as discussed hereinabove.

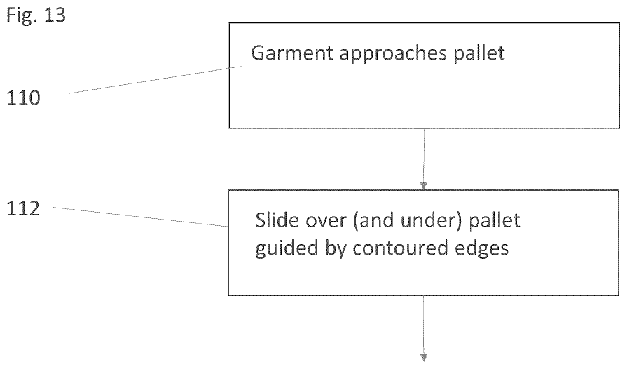

Reference is now made to FIG. 13, which is a simplified flow chart showing a method of palletizing a garment without appendages. The garment is made to approach—110—the pallet and is then made to slide—112—over the pallet, typically by having the base edge of the garment fixed in grippers which pull the garment over the pallet. The rounded contours ensure that the garment slides onto the pallet, so that the garment does not get caught on the edges.

An adhesive-carrying surface or a shaver may be applied to the upper side of the garment to clear the upper side of said garment of dust or lint, as discussed hereinabove.

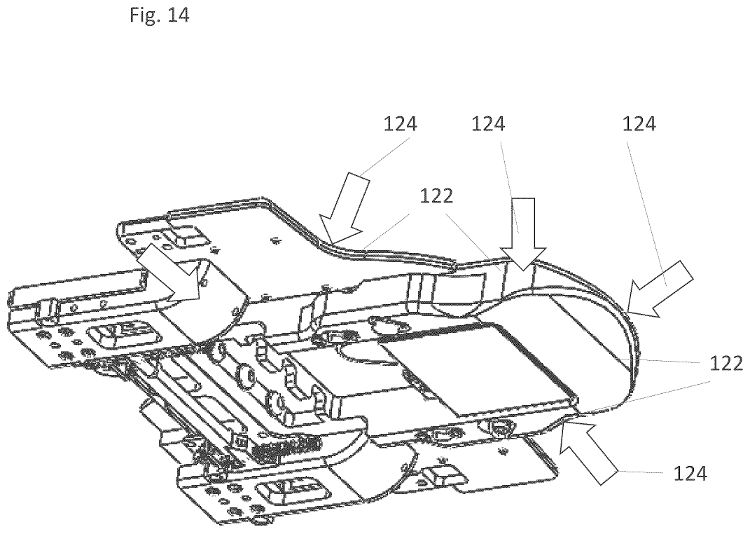

Reference is now made to FIG. 14 which illustrates lower pallet parts according to embodiments of the present invention. The lower pallet 120 is designed to allow the garment lower part, say the back of a shirt, to slide smoothly onto the pallet. Smooth passage of the underside of the garment ensures quicker and easier loading and helps with smoother loading of the upper surface that is being printed on, so that the loading process does not have to be repeated or the garment separately smoothed by the operator. In particular rounded shoulders 122 meet the garment parts approaching from the direction of arrows 124.

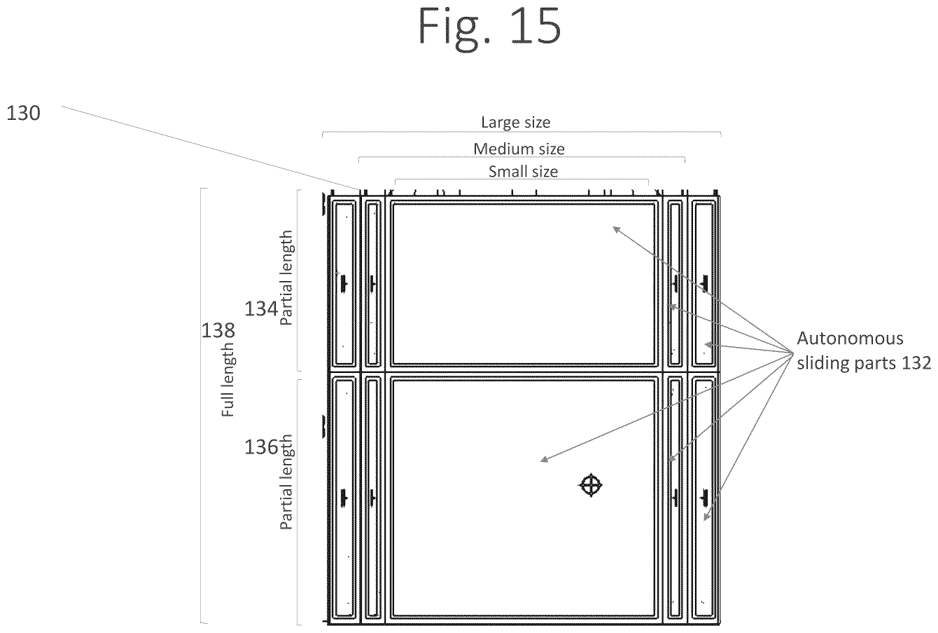

FIG. 15 illustrates multiple autonomous sliding parts that slide in and out of position to reconfigure the pallet for printing different sizes and shapes of garments according to embodiments of the present invention. Pallet upper surface 130 comprises multiple autonomous sliding parts 132 giving adjustable sizings in two dimensions. Thus two partial lengths 134 and 136 in the directions shown as vertical in FIG. 15 provide a full length 138. In the horizontal direction, autonomous sliding parts allow a small size 140 with no extensions, medium size 142 with two extensions and large size 144 with four extensions. The number of extensions used in the horizontal direction is doubled when both partial lengths are being used in the vertical direction. The pallet upper surface for printing is required to be smooth, so the unused surfaces are stored underneath and when needed, are moved into position to be positively located in a way that is flush with the existing surfaces.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. Textile processing apparatus having a configurable form pallet for a garment, the pallet having an approach direction from which a garment to be placed on said pallet approaches the pallet, and a travel direction in which the pallet approaches a processing machine for printing or wherein the processing machine approaches the pallet, the garment having an upper surface and a lower surface, the pallet comprising:
a flat pallet surface; and
a roller coated with adhesive and/or having a shaver attached thereto, and/or having an air flow or vacuum nozzle, the roller being aligned with said flat pallet surface and located in said travel direction, the roller configured to pass over at least a printing area of the upper garment surface to adhesively remove dust, lint and other impurities from the upper garment printing area prior to printing.

2. The apparatus of claim 1, wherein said roller coated with adhesive and/or a shaver is retrievably mounted to advance towards and retreat from a plane of the upper garment surface, or is flexibly mounted, thereby to accommodate local changes in thickness of the garment upper surface.

3. The apparatus of claim 1, wherein said roller coated with adhesive and/or a shaver is flexibly mounted, thereby to accommodate local changes in thickness of the garment upper surface.

4. The apparatus of claim 1, wherein said roller coated with adhesive has first and second ends and a central axis between said first and second ends, the roller rotating around said central axis while held at said central axis by resilient mountings at said first and second ends.

5. A reconfigurable form pallet for a garment having appendages, the pallet having an approach direction from which a garment to be placed on said pallet approaches the pallet, and a travel direction in which the pallet approaches a machine for processing of said garment, the garment having an upper surface and a lower surface, the pallet comprising:
a flat pallet surface; and
a sleeve handling mechanism configured to take hold of said appendages as said garment slides onto said pallet, and hold said appendages away from said flat pallet surface as said garment upper surface settles on said flat pallet surface, thereby to keep said appendages away from said processing of said garment.

6. The apparatus of claim 5, wherein said sleeve handling mechanism comprises arms outwardly located from respective sides of said form pallet, said arms being positioned for said appendages to slide within said arms as said garment slides onto said form pallet.

7. The apparatus of claim 6, wherein said sleeve handling mechanism comprises rounded front contours on respective arms facing said approach direction.

8. The apparatus of claim 5, wherein said arms are configured to rotate inwardly towards said pallet, thereby to fold said appendages into respective sides of said pallet.

9. The apparatus of claim 5, wherein said arms respectively comprise a bar extending outwardly from said arm in a direction away from said pallet, said arms being configured to rotate so that said respective bars fold said appendages towards said pallet.

10. The apparatus of claim 5, wherein said form pallet comprises flaps at respective sides, the flaps being rotatable over a rotating path to close over sides of said garment to pull said upper garment surface taut, and wherein said appendages are placed by said sleeve-handling mechanism into said rotating path, thereby to enable said flaps to close over said appendages.

11. The apparatus of claim 10, wherein said flaps comprise rounded front contours facing said approach direction.

12. The apparatus of claim 5, wherein said sleeve-handling mechanism comprises a mechanical gripper configured to receive each appendage and pull said appendage lengthwise along a side of said pallet.

13. The apparatus of claim 5, wherein said form pallet comprises at least one rounded front contour facing said approach direction.

14. The apparatus of claim 13, wherein said form pallet comprises at least a second rounded front contour facing said approach direction, such that said first of said rounded contours is positioned to guide said garment upper surface to slide over said form pallet and said second of said rounded contours is positioned to guide said garment lower surface to slide under said form pallet.

15. A method of palletizing a garment having appendages, comprising:
causing the garment having appendages to approach a form pallet from an approach direction, the garment having an upper surface and a lower surface;
sliding the garment onto the form pallet such that an upper surface of the garment slides above the form pallet and a lower surface of the garment slides below the form pallet,
holding said appendages as said garment slides onto said pallet aside from said upper surface of said garment.

16. The method of claim 15, wherein said appendages, while being held alongside said pallet are aligned along sides of said pallet.

17. The method of claim 16, wherein said appendages are held by sliding within arms alongside said pallet, the arms rotating inward towards said pallet to align said appendages along said sides.

18. The method of claim 15, wherein said appendages are grabbed by a rotating bar and rotated to align along sides of said pallet.

19. The method of claim 15, comprising gripping said appendages and pulling said appendages along respective sides of said pallet.

20. The method of claim 17, comprising closing flaps over respective sides of said pallet, said flaps thereby holding said sleeves.

21. The method of claim 15, wherein said appendages comprise sleeves.

22. The method of claim 15, further comprising applying an adhesive-coated surface to said upper side of said garment to clear said upper side of said garment of dust or lint.

23. A reconfigurable form pallet for a garment, the pallet having an approach direction from which a garment to be placed on said pallet approaches the pallet, and a travel direction in which the pallet approaches a machine for processing of said garment, the garment having an upper surface and a lower surface, the pallet comprising:
a flat pallet surface; and
at least a first rounded front contour facing said approach direction.

24. The apparatus of claim 23, wherein said form pallet comprises flaps at respective sides, the flaps being rotatable over a rotating path to close over sides of said garment to pull said upper garment surface taut.

25. The apparatus of claim 23, wherein said form pallet comprises at least a second rounded front contour facing said approach direction, such that said first of said rounded contours is positioned to guide said garment upper surface to slide over said form pallet and said second of said rounded contours is positioned to guide said garment lower surface to slide under said form pallet.

26. (canceled)
